(19) United States
(12) Patent Application Publication
(10) Pub. No.: US 2024/0273652 A1
(43) Pub. Date: Aug. 15, 2024

(54) METHOD AND SYSTEM FOR ARRANGING FOOD-INGREDIENTS IN AN INGREDIENTS-COLLECTING-ZONE (ICZ) ACCORDING TO POPULARITY

(71) Applicant: KITCHEN ROBOTICS LTD, Modiin (IL)

(72) Inventors: Yair Gordin, Modiin (IL); David Ben-David, Rehovot (IL)

(73) Assignee: KITCHEN ROBOTICS LTD, Modiin (IL)

(21) Appl. No.: 18/108,636

(22) Filed: Feb. 12, 2023

(51) Int. Cl. G06Q 50/12

(52) U.S. Cl. CPC G06Q 50/12

(57) ABSTRACT

A novel technique for arranging food-ingredients in an ingredients-collecting-zone (ICZ) of an automated cooking restaurant (ACR) is disclosed. Each food ingredient is placed in a food-ingredient-cartridge (FIC). The arranged location of an FIC is based on the popularity of a dish to which the FIC is related.

### CROSS-REFERENCE TO RELATED APPLICATIONS

This is a utility patent application being filed in the United States as a non-provisional application for patent under Title 35 U.S.C. § 100 et seq. and 37 C.F.R. § 1.53(b) and further, this application is related to the following concurrently filed United States non-provisional application for patent, which is incorporated herein in its entirety: the application bearing the title of METHOD AND SYSTEM FOR ARRANGING FOOD-INGREDIENTS IN AN INGREDIENTS-COLLECTING-ZONE (ICZ), filed on Feb. 12, 2023 and assigned Ser. No. 18/108,635.

### FIELD OF THE DISCLOSURE

The present disclosure relates to the field of automated-cooking-restaurant and more particularly the disclosure relates to a novel technique for collecting ingredients for preparing dishes of a menu.

### BACKGROUND

A common automated cooking restaurant (ACR) is configured to work with a library of menus. The menus can be changed daily. Each menu can comprise a plurality of dishes and each dish is associated with a recipe. Each recipe defines ingredients to be used for preparing that relevant dish. Thus, each menu is associated with a plurality of ingredients.

Some of the ingredients may be used in more than one course. Pasta may be used cold in certain dishes of salad and may be used hot in certain courses of Italian food, for example. Further, some of the courses are more popular than others. Hamburger with chips is more popular than Salmon fish with green salad, for example. In addition some of the ingredients might be allergens that may induce allergies to a client. In the following description and claims, the terms dish and course can be used interchangeably.

Currently, an operator of an ACR may obtain the menu of the day associated with a recipe of each dish. Accordingly, the operator may prepare a list of ingredients to be used today. In some occasions, the operator may receive the list of ingredients (Lol) from a chef that prepared the menu. After obtaining the Lol the operator may start the preparation stage. By using the Lol the operator may fill a first food-ingredient-cartridge (FIC) with the first ingredient that is written in the list and put the first FIC in an ingredients-collecting-zone (ICZ) that is associated with the ACR. Then the operator may update an ACR-managing module (AMM) about the location of the first FIC in the ICZ. Updating the AMM can be done via the human interface of the AMM.

Then the operator may move to the second ingredient in the list and fill a second FIC with the second ingredient, puts the second FIC in the ICZ and updating the AMM about the location of the second FIC in the ICZ. The operator may continue, in this process, until the last ingredient in the list. Thus, at the end of the preparation stage the ICZ comprises a plurality of FICs that contain the ingredients that are needed in order to prepare the dishes that appear in the menu of the day

Furthermore, the operator may place the FIC independently whether its associated ingredient contains special properties, such as but not limited to allergen, temperature, ingredients of a vegetarian dish, etc. Consequently a FIC containing allergens material might be placed in high location of the ICZ above one or more lines of FICs. Thus, there is risk that when an ingredient-collecting-vessel (ICV) collects ingredients from a lower FICs, allergens material from an above FIC accidently may fall into the ICV.

During the ongoing stage, based on the recipe of a current prepared course, an ICV may be moved up and down left and right along the ICZ in order to collect the required ingredients for preparing this dish. In the following description and claims, the terms ICV can be a pot, a cooking device, a serving plate, a vessel etc. Along the present disclosure and the claims the term pot may be used as a representative term for an ICV.

Based on the information on the location of each FIC of a recipe the pot may be moved to the top left of the ICZ in order to collect a first ingredient, then to the bottom right of the ICZ in order to collect a second ingredient, then to the center of the ICZ in order to collect a 3^{rd} ingredient, and so on until collecting all the ingredients that are needed for preparing the current course. Thus, the movement of the pot is not optimal. In addition from time to time a FIC that is associated with a popular dish may become empty forcing the operator to stop the operation of the ICZ in order to allow the operator to replace the empty FIC with a full FIC.

Consequently, dispensing of food ingredients is a key factor in automated food preparation processes. Performance and efficiency of food preparation automated systems is highly dependent on factors such as food ingredient dispensing speed, accuracy, ingredient refill duration, cleaning and maintenance duration, etc.

### BRIEF SUMMARY

The needs and the deficiencies that are described above are not intended to limit the scope of the inventive concepts of the present disclosure in any manner. The needs are presented for illustration only. The disclosure is directed to a novel technique for collection of food ingredients.

An example of Food-Ingredients-Collecting-Process (FICP) per menu may comprise several phases. The first phase is data collection phase. This phase can be done offline once per a menu after preparing the menu. The AMM may present a table TB1 to the chef and prompting the chef to fill it. TB1 may have a plurality of lines, each line can be associated with an ingredient. In addition the table may have a plurality of columns.

Each column can be associated with a special property of that ingredient. The special property may be such as but not limited to allergen, high temperature, low temperature, ingredients of a vegetarian dish, etc. Which food ingredients cannot be placed in adjacent to another in order to avoid block, or temperature drift, etc. Further, an FIC that contains ingredients of a vegetarian dish may be place in the top line of the ICZ, to avoid an accidental dropping of piece of meat, fish or chicken into that FIC. Next the AMM may prompt the chef to fill the cells of the table. TB1 can be kept and be used again and again per that menu.

The second phase of the FICP can be referred as the site-learning-phase (SLP). The term site refers to the area that is served by that ACR. During the SLP the AMM may study the behavior of that site. In some example embodiments of the FICP the AMM may learn which dishes are popular in that site. Other example embodiment of the FICP may learn which ingredients are popular in that site, etc. This phase may take a long period of time, between three to nine months, for example. A common SLP can be six months, for example.

In an embodiment of FICP that is related to courses, then during the SLP the AMM may use a second table, TB2. TB2 may have a plurality of lines and three columns, for example. Each line in the first column can be associated with a course from the menu and the second column can be associated with the number of orders of that course. The 3^{rd} column can present the percentage of ordering this course out of the total amount of ordering courses during the period of the SLP.

In an example embodiment of FICP that is related to food ingredients, then during the SLP the AMM may associate each line in the first column of TB2′ with an ingredient that is related to that menu. The second column of TB2′ can be associated with the number of times that this food ingredient was collected from the ICZ. The 3^{rd} column of TB2′ can present the percentage of collecting this ingredient out of the total amount of events that ingredients were collected from the ICZ during the period of the SLP.

The 3^{rd} phase of FICP can be referred as the processing stage. During this phase the AMM may process the information collected during the previous two phases in order to offer one or more setups of FICs in the ICZ. The setup takes into consideration the popularity of a dish as well as the properties of the ingredients. FICs that contain allergens can be placed in the lowest row of the ICZ, for example. A mark that indicates that first ingredient from a certain FIC has to be collected first and another mark that indicates that a second ingredient from a second FIC has to be collected at the end of the collecting process. Those markers can be used in order to separate between two ingredients that cannot be placed in adjacent to each other.

Information related to the properties of different ingredients can be added manually by the chef, for example. Alternatively, the information can be added automatically by collecting it from databases. An example to such a database can be the database of the U.S. Department of Agriculture (USDA). Along the description and the claims the terms properties and features may be used interchangeably.

An example embodiment of FICP, based on information stored in TB2, may generate a 3^{rd} table TB2P of dishes by organizing the dishes according to the popularity of each dish. Placing the most popular dish at the top of the TB2P and the less popular dish at the bottom TB2P. Then, the FICP may place the FICs of the most popular dish around the center of the ICZ and continues in a spiral path with the FICs of this dish. Next the FICP may place the FICs of the second popular dish and place them in an area close to the area of the first dish, and so on. Thus, the FICs of the last popular dish will be in an area at the far end of the ICZ. The location of each FIC can be written in TB2P by the FICP. Some embodiments of the FICP may double the FICs of the most popular dishes in order to avoid stooping of the operation of the ICZ when a FIC becomes empty.

Another example embodiment of the FICP, based TB2′, may generate a new table TB2′P of ingredients according to their popularity. Placing the most popular FIC at the top of TB2′P and less popular FIC at the bottom of TB2′P. Then, the AMM may place the most popular FIC at the center of the ICZ and continues in a spiral path with the next popular FIC and so on. Thus, the less popular FIC will be at the far end of the ICZ. Some embodiments of FICP may double the FICs of the popular ingredients in order to avoid stooping of the operation of the ICZ when a FIC becomes empty.

Other embodiment of FICP may organize the FICs based on the properties of the ingredients. FIC that contain allergens can be placed in the lowest row of the ICZ. FIC that contains ingredients of a vegetarian dish may be place in the top line of the ICZ, to avoid an accidental dropping of piece of meat, fish, or chicken into that FIC, etc.

At the end of the FICP, TB2P or TB2′P may be presented to the operator on the display of the AMM and/or be printed and be delivered to the operator. According to TB2P or TB2′P the operator may put the FICs in the ICZ.

These and other aspects of the disclosure will be apparent in view of the attached figures and detailed description. The foregoing summary is not intended to summarize each potential embodiment or every aspect of the present invention, and other features and advantages of the present invention will become apparent upon reading the following detailed description of the embodiments with the accompanying drawings and appended claims.

Further, although specific embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

### BRIEF DESCRIPTION OF THE DRAWINGS

Some examples of embodiments of the present disclosure will be understood and appreciated more fully from the following detailed description, taken in conjunction with the drawings in which:

FIG. 1 schematically illustrates a block diagram with relevant elements of an example of an ACR-managing-module (AMM);

FIG. 2 illustrates a flowchart with relevant actions that can be implemented for handling a new menu;

FIG. 3 illustrates a flowchart with relevant actions that can be implemented for learning the behavior of a site; and

FIG. 4 illustrates a flowchart with relevant actions that can be implemented while preparing a setup of an ingredients-collecting-zone (ICZ).

### DETAILED DESCRIPTION OF SOME EXAMPLE EMBODIMENTS

Turning now to the figures in which like numerals represent like elements throughout the several views, in which exemplary embodiments of the disclosed techniques are described. For convenience, only some elements of the same group may be labeled with numerals.

The purpose of the drawings is to describe examples of embodiments and not for production purpose. Therefore, features shown in the figures are chosen for convenience and clarity of presentation only. Moreover, the language used in this disclosure has been principally selected for readability and instructional purposes, and may not have been selected to define or limit the inventive subject matter, resort to the claims being necessary to determine such inventive subject matter.

In this specification, these implementations, or any other form that the invention may take, may be referred to as techniques. In general, the order of the steps of disclosed processes may be altered within the scope of the invention. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following description and claims, the words “unit,” “element,” “module”, and “logical module” may be used interchangeably. Anything designated as a unit or module may be a stand-alone unit or a specialized or integrated module. A unit or a module may be modular or have modular aspects allowing it to be easily removed and replaced with another similar unit or module. In addition the terms element and section can be used interchangeably. In the following description and claims, the words “course,” “dish”, and “meal” may be used interchangeably

Each unit or module may be any one of, or any combination of, software, hardware, and/or firmware, ultimately resulting in one or more processors programmed to execute the functionality ascribed to the unit or module. Additionally, multiple modules of the same or different types may be implemented by a single processor. As used herein, the term ‘processor’ can refer to a computer such as but not limited to Intel NUC, wherein NUC stands for Next-Unit-of-Computing or “Amazon EC2 A1 Instances” or “Amazon EC2 P3 Instances”, which are maintained by Amazon Crop USA, for example. Other example embodiments of the disclosed technique may use cloud resources as processors, servers, non-transitory computer readable storage devices, etc.

Software of a logical module may be embodied on a computer readable device such as but not limited to a read/write solid-state disc (SSD), CDROM, Flash memory, ROM, or other non-transitory computer readable storage device, etc. In order to execute a certain task a software program may be loaded to an appropriate processor as needed. In the present disclosure the terms task, method, process can be used interchangeably. In the present disclosure the verbs transmit, transfer or be placed in a queue can be used interchangeably.

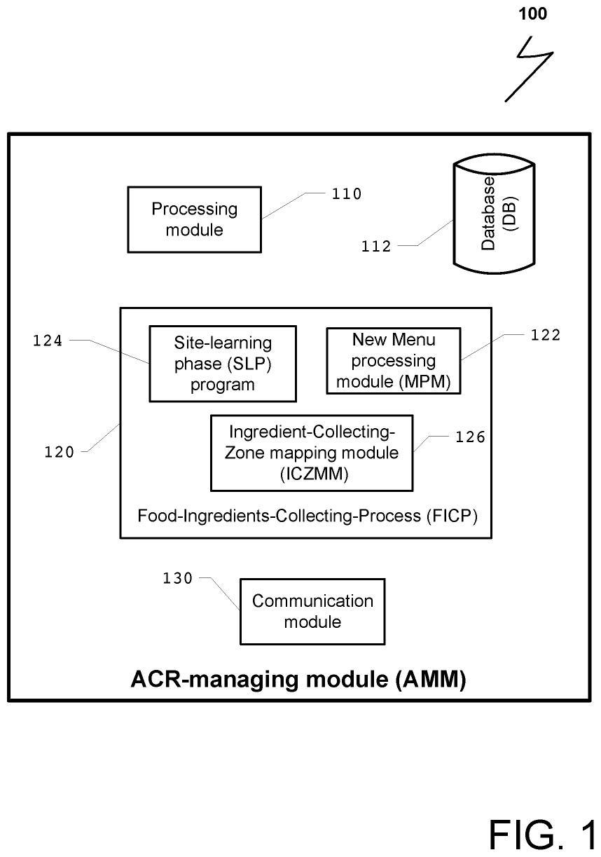

FIG. 1 schematically illustrates a block diagram with relevant elements of an example of an ACR-managing-module (AMM) 100. Example embodiments of AMM 100, among other tasks, are configured to collect food ingredients. AMM 100 may comprise a processing module 110, a non-transitory computer readable storage device, database 112, a Food-Ingredients-Collecting-Process (FICP) 120, and communication module 130. The communication module 130 handles the communication between the elements of AMM 100 and one or more ACRs and one or more clients and the communication with the operator workstation. The communication can be based on Internet Protocol (IP). Communication over an IP network is well known to a person having an ordinary skill in the art and will not be further disclosed.

Processing module 110 may comprise a non-transitory computer readable storage device and a processor. The processor can be a computer such as but not limited to Intel NUC, wherein NUC stands for Next-Unit-of-Computing or “Amazon EC2 A1 Instances” or “Amazon EC2 P3 Instances”, which are maintained by Amazon Crop USA, for example. Other example embodiments of the disclosed technique may use cloud resources as processors, servers, non-transitory computer readable storage devices, etc.

The non-transitory computer readable storage device may store programs, tables and data that are used during the operation of the processor. Database 112 may store data related to the different menus that are served by AMM 100. The data may comprise data that is related to ingredients that are used, properties of the different ingredients, setups (mapping) of the ICZ for old menus, etc.

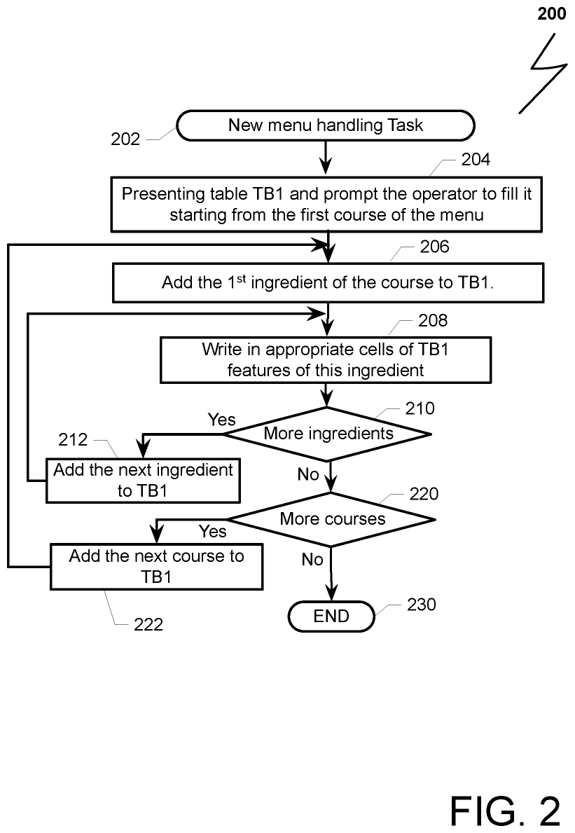

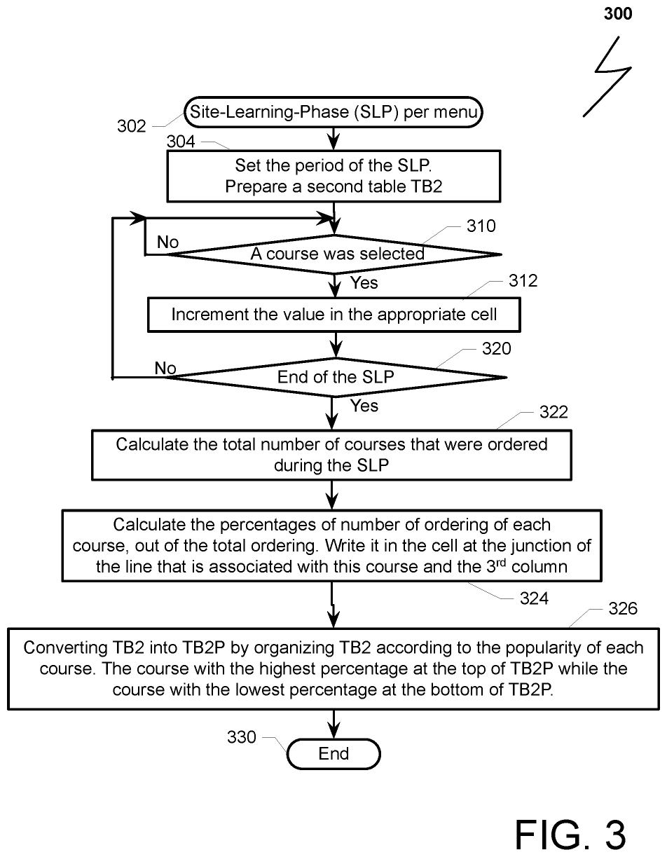

The FICP 120 can be a non-transitory computer readable storage device that may store software programs to be used in order to support the ingredients collecting phase. The non-transitory computer readable storage device can be such as but not limited to a read/write hard disc, CDROM, Flash memory, ROM, etc. Program 122 when is loaded to an appropriate processor, the processor may process a new menu. The new menu can be organized in TB1 and TB2. More information on the operation of program 122 is disclosed below in conjunction with FIG. 2. Software program 124 when is loaded to an appropriate processor, the processor may execute the site-learning-phase (SLP). At the end of this task the processor may associate the percentages of ordering each dish during the site learning phase (SLP). More information about this program is disclosed below in conjunction with FIG. 3.

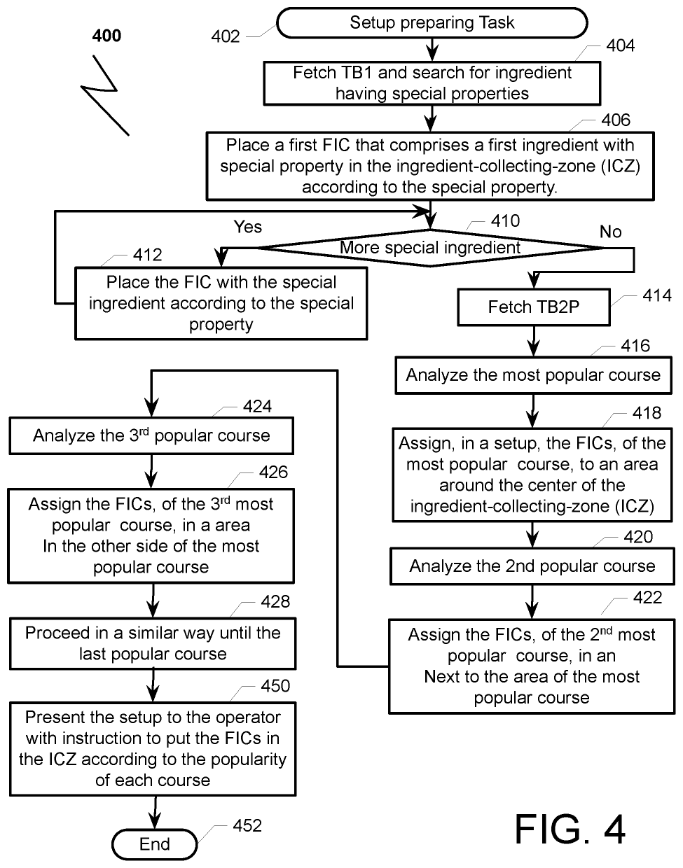

Program 126 when is loaded to an appropriate processor, the processor may process the collected information in order to offer a map (setup) of the ingredients collecting zone. This module can be referred as Ingredients-collecting-Zone mapping module (ICZMM). More information about the ICZMM 126 is disclosed below in conjunction with FIG. 4.

FIG. 2 illustrates a flowchart with relevant actions of process 200 that can be implemented for collecting data related to a new menu. Process 200 can be initiated 202 by an operator. In some cases the operator can be the chef that is associated with a certain ACR. In other cases the operator can be an employee of the manufacture of the ACR that loads the AMM with few preliminary menus. After initiation, table TB1 can be presented 204 to the operator and process 200 may prompt 204 the operator to fill it starting from the first dish of the menu. TB1 may have a plurality of lines, each line can be associated with an ingredient. In addition the table may have a plurality of columns. Each column can be associated with a feature of the ingredient.

The first ingredient of that course can be added 206 to TB1. Next the operator is prompted to add 208 features of that ingredient in the relevant cells of that line. Features such as but not limited to allergen, hot, cold, etc. Then a decision is made 210 whether that dish has more ingredients. If 210 yes, then at block 212 the next ingredient is added to TB1 and process 200 returns to block 208. If 210 there are no more ingredients in that dish, then at block 220 a decision is made whether there are more courses in the menu.

If 220 yes, there are more courses in the menu, then the next course is added 222 to TB1 and process 200 returns to block 206 for handling the next course. If 220 there are no more courses, then process 200 is terminated 230 and TB1 is ready to be used.

FIG. 3 illustrates a flowchart with relevant actions that can be implemented by process 300 for learning the behavior of a new site. Alternatively process 300 can be executed for learning the behavior of an existing site to a new menu. Process 300 can be initiated 302 by an operator of the new site or by the chef of an existing site while lunching a new menu.

After initiation the operator is prompt to define 304 the period of time the learning phase. The period of time can be between three to nine months, for example. A common SLP can be six months, for example. In addition table TB2 can be prepared. Table TB2 may have a plurality of lines and three columns, for example. Each line in the first column can be associated with a course from the menu and the second column can be associated with the number of orders of that course. The 3^{rd} column can present the percentage of ordering this course out of the total amount of ordering courses during the period of the SLP.

After preparing TB2 process 300 may wait 310 until a course is selected by a customer. When a course is selected, process 300 may search TB2 for the line that is associated with that course and then the value that is written in the relevant cell is incremented 312 by one. Next a decision is made 320 whether the site-learning-phase is terminated. If 320 no, process 300 may return to block 310 waiting for the next order. If 320 the SLP is terminated, then at block 322 the total number of courses that were ordered during the SLP is calculated and be written in TB2.

Next, at block 324 the percentages of number of ordering each course out of the total ordering are calculated and be written in TB2 in the cell at the junction of the line that is related to that course and the 3^{rd} column. At block 326 TB2P is prepared by organizing TB2 according to the popularity of each course. The course with the highest at the top of TB2P and the course with the lowest percentages at the last line of TB2P. Next Process 300 can be terminated 330.

Some example embodiment of process 300 can be configured to compare properties of a new site to existing sites. In case that the new site looks similar to an existing site, then the period of the SLP can be shorter, taking into consideration the popularity of the dishes that were found in the existing site, which is similar to the new site.

Referring now to FIG. 4 that illustrates a flowchart with relevant actions that can be implemented by process 400 for preparing a setup of FICs in the ICZ according to an example embodiment of a FICP. The prepared setup is based on properties of the ingredients as well as the popularity of the dishes of the served menu. Process 400 may be initiated 402 by an operator of an ACR before filling the ICZ with the ingredients of a current menu. At block 404 TB1 is fetched and be searched looking for a first ingredient having special properties. The special properties may comprise properties such as but not limited to allergen, temperature, ingredients of a vegetarian dish, etc.

Then at block 406 the location of that FIC in the ICZ is marked according to their special property. FIC having allergen can be marked to be placed in the lowest row of the ICZ. FICs that contain ingredients of vegetarian dish can be marked to be placed in the top line of the ICZ. FIC that contains hot ingredient can be placed detached from a FIC that contains cold ingredient, etc. Next 410 a decision is made whether there is an additional special ingredient. If 410 yes, then at block 412 the FIC of that ingredient is placed according to its special property and process 400 returns to block 410.

If 410 there are no more special ingredients, then at block 414 TB2P is fetched and the most popular dish is analyzed 416 in order to define its associated FICs. Next the FICs of the most popular dish can be assigned 418 to an area around the center of the ICZ. In some cases the area can be a substantially circle. In other cases the area can be a substantially square. Assigning the FICs can be done in a spiral mode in order to reduce the distances that the ICV has to do in order to collect the ingredients of the most popular dish.

At block 420 the second popular dish can be analyzed in order to define its associated FICs. Next the FICs of the second most popular dish can be assigned 422 to an area next to the area of the most popular dish. In some cases the area can be a circle. In other cases the area can be a square. Assigning the FICs can be done in a spiral mode in order to reduce the distances that the ICV has to do in order to collect the ingredients of the second popular dish.

At block 424 the 3^{rd} popular dish can be analyzed in order to define its associated FICs. Next the FICs of the second most popular dish can be assigned 426 to an area on the other side of the area of the most popular dish. In some cases the area can be a circle. In other cases the area can be a square. Assigning the FICs can be done in a spiral mode in order reduce the distances that the ICV has to do in order to collect the ingredients of the 3^{rd} popular dish.

In some example embodiments of process 400 assigning (418, 422, 426) the location of each FIC in the ICZ can be done by dividing the ICZ into rows and columns. Each column can be marked with a letter and each column can be marked by number. Thus, the location of each FIC can be defined by the letter that is assigned to the relevant row and the number that is assigned to the relevant column. For example, the location “B5” of an FIC means that the FIC has to be placed in the cell, of ICZ, at the junction of row “B” and column “5”.

Next process 400 may proceed 428 in a similar way until the last popular dish of the menu. Then the setup can be presented 450 to the operator of the ACR. In some example embodiments presenting the setup can be done by a table TB3. In TB3 each line is associated with a FIC and the column is associated with the location of this FIC. Then process 400 can be terminated 452.

In the description and claims of the present disclosure, each of the verbs, “comprise”, “include”, “have”, and conjugates thereof, are used to indicate that the object or objects of the verb are not necessarily a complete listing of members, components, elements, or parts of the subject or subjects of the verb.

The present disclosure has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons skilled in the art that the present invention is not limited by what has been particularly shown and described herein above. Rather the scope of the invention is defined by the claims that follow.

We claim:

1. A non-transitory computer readable storage device comprising executable instructions that when executed cause a processor at an automated-cooking-restaurant (ACR) managing module (AMM):
i. to obtain a list of dishes that are related to a menu;
ii. to define the popularity of each dish;
iii. to assign, per each food-ingredient, a location in the ICZ according to the popularity of its related dish.

2. The non-transitory computer readable storage device of claim 1, wherein each food-ingredient is located in a food-ingredient-cartridge (FIC).

3. The non-transitory computer readable storage device of claim 2, wherein the location that is assigned to FICs with food-ingredients of the most popular dish is in an area that is substantially in the center of the ICZ.

4. The non-transitory computer readable storage device of claim 3, wherein the shape of the area is substantially a circle.

5. The non-transitory computer readable storage device of claim 3, wherein food-ingredients of the second most popular dish are placed in an area that is next to the area assigned to the most popular dish.

6. The non-transitory computer readable storage device of claim 3, wherein the FICs are placed in a spiral mode.

7. The non-transitory computer readable storage device of claim 1, wherein the popularity of a dish is defined based on the number of times that the dish was ordered out of the total number orders of different dishes during a period of time.

8. The non-transitory computer readable storage device of claim 7, wherein the period of time is in the range of three to nine months.

9. The non-transitory computer readable storage device of claim 8, wherein the period of time is six months.

10. The non-transitory computer readable storage device of claim 1, wherein the storage device is a solid state disc.

11. The non-transitory computer readable storage device of claim 1, wherein the processor is Intel Next-Unit-of Computing (NUC).

12. A system for arranging food-ingredient in an ingredients-collecting-zone (ICZ), the system comprising:
i. a non-transitory computer readable storage device that stores one or more tables that are used for arranging the food ingredients according to the popularity of their associated dishes;
ii. a processing module that is configured to arrange the plurality of food-ingredients in the ICZ based on the popularity of their associated dish; and
iii. a communication configured to communicate with an operator of the ICZ.

13. The system of claim 12, wherein each food-ingredient is located in a food-ingredient-cartridge (FIC).

14. The system of claim 13, wherein the processing module is configured to place FICs with food-ingredients of the most popular dish in an area that is substantially in the center of the ICZ.

15. The system of claim 14, wherein the shape of the area is substantially a circle.

16. The system of claim 14, wherein FICs that contains food-ingredients of the second most popular dish are placed in an area that is next to the area of the most popular dish.

17. The system of claim 14, wherein the FICs are placed in a spiral mode.

18. The system of claim 1, wherein the popularity of a dish is defined based on the number of time that the dish was order out of the total number orders of different dishes during a period of time.

19. The system of claim 19, wherein the wherein the period of time is in the range of three to nine months.

20. The system of claim 19, wherein the period of time is six months.
